(19) United States
(12) Patent Application Publication
(10) Pub. No.: US 2014/0183399 A1
(43) Pub. Date: Jul. 3, 2014

(54) FIRE-EXTINGUISHING COMPOSITION COMPRISING ORGANIC ACID COMPOUND

(71) Applicants: Junna Yao, Shaanxi (CN); Yi Liu, Shaanxi (CN)

(72) Inventors: Junna Yao, Shaanxi (CN); Yi Liu, Shaanxi (CN)

(73) Assignee: XI'AN J&R FIRE FIGHTING EQUIPMENT CO., LTD., SHAANXI (CN)

(21) Appl. No.: 14/239,112

(22) PCT Filed: Aug. 14, 2012
(86) PCT No.: PCT/CN2012/080091

§ 371 Date: Feb. 14, 2014

(30) Foreign Application Priority Data
Aug. 16, 2011 (CN) 201110235101.3

(51) Int. Cl. A62D 1/00

(52) U.S. Cl. CPC A62D 1/0007
USPC 252/2

(57) ABSTRACT

The disclosure relates to a fire-extinguishing composition comprising an organic acid compound, wherein the fire-extinguishing composition comprises an organic acid compound. The content of the organic acid compound is 50% by mass or more, and preferably 70% to 90% by mass. The organic acid compound according to the disclosure may absorb heat and be decomposed at a high temperature, and release a fire-extinguishing substance. The fire-extinguishing substance may react, by means of free radicals, with one or more of O., OH., H. free radicals that are necessary for chemical-looping combustion, thus cutting off the chemical-looping combustion, or may reduce the oxygen partial pressure by physical action to inhibit the flame, or achieve the fire-extinguishing effect by both the physical and chemical inhibition effects. At the same time, the organic acid compound achieves a synergistic effect together with a pyrotechnic agent, thereby further improving the fire-extinguishing performance of the fire-extinguishing agent, and greatly shortening the effective fire-extinguishing time.

The application depends on and claims the priority of Chinese patent application 201110235101.3, filed on Aug. 16, 2011, the entire contents of which are incorporated herein by reference.

### TECHNICAL FIELD

The disclosure belongs to the technical field of aerosol fire extinguishment, and particularly relating to a fire-extinguishing composition that can be heated to be decomposed to generate a fire-extinguishing substance.

### BACKGROUND

Since the specific objective of replacing the Halon fire extinguishing agent were proposed to each country by the Canada Montreal Convention in 1987, all countries over the world are dedicated to the study on new fire-extinguishing technologies, therefore, the fire-extinguishing technology with high efficiency in fire-extinguishing and without pollution for environment has become the target for people to strive. Since the fire extinguishing systems such as gas fire extinguishing system, powder fire extinguishing system, water type fire extinguishing system and so on are environmentall-friendly, they are widely used as substitutes of the Halon fire extinguishing agent. They

[symbol]

However, all the fire extinguishing system should be stored under high pressure, not only occupy a large volume, but also have the risk of physical explosion during storage. The document “Security Analysis of Gas Fire extinguishing Systems” (Fire Science and Technology 2002 21(5)) analyzes the risk that exist in gas fire extinguishing system, and enumerates the accidents caused by using the gas fire extinguishing system kept under pressure.

In recent years, people have been studing Halon substitute fire extinguishing substances, wherein the Next Generation Fire Extinguishing Technology Project Group (NGP) of the Building and Fire Research Centre of the U.S. National Institute of Standards and Technology (NIST) have done a tremendous amount of experimental researches in pursuing a variety of novel fire extinguishing substances, the process includes: heating nitrogen, carbon dioxide and CF₃H, and then heating test substances with these high-temperature gases, the test substances are then decomposed under high temperature and acts on the flame together with the gases; According to the experiments, we find that the products generated by heating and decomposing some test substances can significantly improve the fire-extinguishing effect of the nitrogen, carbon dioxide and CF₃H gas (Halon Options Technical Working Conference, April 2001, Albuquerque, N. Mex., Suppression of cup-burner diffusion flames by super-effective chemical inhibitors and inert compounds; Combustion and Flame 129:221-238(2002) Inhibition of Premixed Methane Flame by Manganese and Tin Compounds, Halon Options Technical Working Conference May 2000, flame inhibition by ferrocene, alone and with CO₂ and CF₃H).

However, the researches of the project group are just based on laboratory theoretical researches, without practical application in fire extinguishers.

Existing aerosol fire extinguishing agents mainly include S type and K-type fire extinguishing agents, by comprehensively analyzing the performance characteristics, the disadvantages are mainly as follows: all the aerosol fire extinguishing agents use fire extinguishing agents to generate an oxidation-reduction reaction, which releases a large number of gases and active particles to achieve the chemical and physical combination fire-extinguishing purpose via the chain scission reaction of the active particles and the coverage smothering of the large number of gases. Aerosol generating agents can release fire-extinguishing substances during combustion reactions while releasing a large amount of heat. In order to effectively lower the temperature of a device and an aerosol, and avoid a secondary fire, a cooling system needs to be installed, which causes a complex and bulky device structure, complex technical process and high cost. Because of the existence of the cooling system, a large number of active particles are inactivated, and the performance of the fire extinguishing is greatly reduced.

### SUMMARY

In order to solve the above technical problems existing in fire-extinguishing compositions in the prior art, the inventor invents a fire-extinguishing composition comprising an organic acid compound with better fire-extinguishing effect and higher safety performance.

A technical solution applied by the disclosure as follows:

a fire-extinguishing composition comprising an organic acid compound is special in that: the fire-extinguishing composition comprises an organic acid compound; wherein the content of the organic acid compound is 50% by mass or more, and preferably 70% to 90% by mass; the organic acid compound according the disclosure may absorb heat and be decomposed at a high temperature, and release a fire-extinguishing substance, the fire-extinguishing substance may react, by means of free radicals, with one or more of O., OH., H. free radicals that are necessary for chemical-looping combustion, thus cutting off the chemical-looping combustion, or may reduce the oxygen partial pressure by physical action to inhibit the flame, or achieve the fire-extinguishing effect by both the physical and chemical inhibition effects. At the same time, the organic acid compound achieves a synergistic effect together with a pyrotechnic agent, thereby further improving the fire-extinguishing performance of the fire-extinguishing agent, and greatly shortening the effective fire-extinguishing time.

To improve the fire-extinguishing performance of the main fire-extinguishing material, i.e. the organic acid compound, a flame retardant may be further added to the above fire-extinguishing composition, i.e. a bromine-based flame retardant, a chlorine-based flame retardant, an organophosphorus-based flame retardant, a phosphorus-halogen based flame retardant, a nitrogen-based and phosphorus-nitrogen flame retardant, or other flame retardants, or any combination thereof, and specifically may be diammonium phosphate, ammonium dihydrogen phosphate, dicyandiamide, melamine, tetrabromobisphenol A, tetrachlorobisphenol A, decabromodiphenyl ether, DOPO, tris(dibromophenyl)phosphate, melamine, monomelamine phosphate, guanidine phosphate, guanidine carbonate, dicyandiamide, ammonium polyphosphate and so on; wherein the content of the flame retardant in the fire-extinguishing composition is smaller than 50% by mass, or may be below 40%, preferably below 30%, and optimally 4% to 25%.

To improve the processability of the main fire-extinguishing material, i.e. the organic acid compound, an additive may be further added to the fire-extinguishing composition of the disclosure, wherein the content of the additive is 0.1% to 10% by mass, preferably 0.1% to 5%; the additive may be a water-soluble compound solution or a mixture thereof of a stearate, graphite, and a polymer, or may be also one or more of water glass, phenol resin, shellac and starch, which depends on application conditions.

An auxiliary fire-extinguishing material may be further added to the fire-extinguishing composition of the disclosure in a content that may be controlled at 0% to 30% by mass, preferably 4% to 25%; the auxiliary fire-extinguishing material may be selected from ferrocene or ferrocenyl derivatives, or a mixture of ferrocene and the derivatives thereof, or may be also one or a combination of manganese carbonate, basic copper carbonate, basic magnesium carbonate, ferrous carbonate, potassium citrate, sodium citrate, ammonium citrate, ammonium ferric citrate, potassium oxalate, sodium oxalate, ammonium oxalate, iron oxalate, magnesium oxalate, manganese oxalate and copper oxalate.

The organic acid compound of the disclosure may be capric acid, dodecanoic acid, tetradecanoic acid, hexadecanoic acid, heptadecanoic acid, octadecanoic acid, eicosanoic acid, docosanoic acid, hexacosanoic acid, hentriacontylic acid, dotriacontanoic acid, crotonic acid, oleic acid, heptadecenoic acid, hexadecenoic acid, hexadienic acid, oxalic acid, malonic acid, succinic acid, glutaric acid, pimelic acid, suberic acid, sebacic acid, brassylic acid, hexadecanedioic acid, cis-crotonic acid, trans-crotonic acid, 2-hydroxypropionic acid, 2-hydroxybutanedioic acid, 2,3-dihydroxybutanedioic acid, 2-hydroxy-1,2,3-propanetricarboxylic acid, 3-phenyl-2-propenoic acid, 2-hydroxybenzoic acid, 3,4,5-trihydroxy benzoic acid, benzoic acid or methylguanidoacetic acid.

The fire-extinguishing composition comprising an organic acid compound of the disclosure has the following advantages:

firstly, the fire-extinguishing composition of the disclosure comprises an organic acid compound and is capable of releasing a fire extinguishing substance at the moment of being heated to be decomposed, so as to extinguish a fire using a physical or chemical inhibition effect, or a physical and chemical synergistic inhibition effect of the fire extinguishing substance; in addition, the fire-extinguishing composition of the disclosure also optimizes for the content of the main fire-extinguishing material to exert the best fire-extinguishing effect, so that the fire-extinguishing effect is greatly improved, the fire-extinguishing time is shortened and the fire-extinguishing efficiency of the fire-extinguishing composition is improved.

secondly, a flame retardant, an additive, and other auxiliary fire-extinguishing materials are added to the fire-extinguishing composition of the disclosure, thus further improving the fire-extinguishing performance and processability of the main fire-extinguishing material, i.e. the organic acid compound, making the fire-extinguishing composition stable in performance and easy in long-term storage.

thirdly, the fire-extinguishing composition of the disclosure is more convenient in using with pyrotechnic agent as a heat source.

fourthly, when heated, the fire-extinguishing composition of the disclosure can absorb heat and be decomposed rapidly, thus effectively and rapidly reducing the heat released by combustion of the pyrotechnic agent, greatly reducing the temperature of the nozzle of the fire-extinguishing apparatus and the sprayed substance and achieving higher safety.

### DETAILED DESCRIPTION OF THE EMBODIMENTS

Embodiments of a fire-extinguishing composition comprising an organic acid compound of the disclosure will be described as below in conjunction with experiments:

the fire-extinguishing composition contains an organic acid compound, wherein the content of the organic acid compound is 50% by mass or more, preferably 70% to 90% by mass, and the organic acid compound may be selected from capric acid, dodecanoic acid, tetradecanoic acid, hexadecanoic acid, heptadecanoic acid, octadecanoic acid, eicosanoic acid, docosanoic acid, hexacosanoic acid, hentriacontylic acid, dotriacontanoic acid, crotonic acid, oleic acid, heptadecenoic acid, hexadecenoic acid, hexadienic acid, oxalic acid, malonic acid, succinic acid, glutaric acid, pimelic acid, suberic acid, sebacic acid, brassylic acid, hexadecanedioic acid, cis-crotonic acid, trans-crotonic acid, 2-hydroxypropionic acid, 2-hydroxybutanedioic acid, 2,3-dihydroxybutanedioic acid, 2-hydroxy-1,2,3-propanetricarboxylic acid, 3-phenyl-2-propenoic acid, 2-hydroxybenzoic acid, 3,4,5-trihydroxy benzoic acid, benzoic acid or methylguanidoacetic acid etc., and all these can absorb heat to be decomposed at a high temperature to release a fire-extinguishing substance. The fire-extinguishing substance may react, by means of free radicals, with one or more of O., OH., H. free radicals that are necessary for chemical-looping combustion, thus cutting off the chemical-looping combustion, or may reduce the oxygen partial pressure by physical action to inhibit the flame, or achieve the fire-extinguishing effect by both the physical and chemical inhibition effects. At the same time, the organic acid compound achieves a synergistic effect together with a pyrotechnic agent, thereby further improving the fire-extinguishing performance of the fire-extinguishing agent, and greatly shortening the effective fire-extinguishing time.

To improve the fire-extinguishing performance of the main fire-extinguishing material, i.e. the organic acid compound, a flame retardant may be further added to the fire-extinguishing composition, i.e. a bromine-based flame retardant, a chlorine-based flame retardant, an organophosphorus-based flame retardant, a phosphorus-halogen based flame retardant, a nitrogen-based and phosphorus-nitrogen flame retardant, an inorganic flame retardant, or any combination thereof, and specifically may be diammonium phosphate, ammonium dihydrogen phosphate, dicyandiamide, melamine, tetrabromobisphenol A, tetrachlorobisphenol A, decabromodiphenyl ether, DOPO, tris(dibromophenyl)phosphate, melamine, monomelamine phosphate, guanidine phosphate, guanidine carbonate, dicyandiamide ammonium polyphosphate and so on, and is not limited thereby, any flame retardant that can be mixed with the organic acid compound to achieve a good fire-extinguishing effect may be applied. wherein the content of the flame retardant in the fire-extinguishing composition is smaller than 50% by mass, or may be below 40%, preferably below 30%, and optimally 4% to 25%, which is adjusted according to specific proportions.

To improve the processability of the main fire-extinguishing material, i.e. the organic acid compound, an additive may be further added to the fire-extinguishing composition of the disclosure, wherein the content of the additive is 0.1% to 10% by mass, preferably 0.1% to 5%; the additive may be a water-soluble compound solution or a mixture thereof of a stearate, graphite, and a polymer, or may be also one or more of water glass, phenol resin, shellac and starch, which depends on application conditions, wherein the additive contains an adhesive which belongs to general knowledge in the art. Generally, the content of the additive in the fire-extinguishing composition is controlled below 15% by mass.

An auxiliary fire-extinguishing material may be further added to the fire-extinguishing composition of the disclorure in a content that may be controlled at 0% to 30% by mass, preferably 4% to 25%; the auxiliary fire-extinguishing material may be selected from ferrocene or ferrocenyl derivative, or a mixture of ferrocene and the derivatives thereof, or may be also one or a combination of manganese carbonate, basic copper carbonate, basic magnesium carbonate, ferrous carbonate, potassium citrate, sodium citrate, ammonium citrate, ammonium ferric citrate, potassium oxalate, sodium oxalate, ammonium oxalate, iron oxalate, magnesium oxalate, manganese oxalate and copper oxalate.

65 g of a prepared tablet fire-extinguishing composition is respectively added to a fire-extinguishing apparatuses charged with a 50 g K-type hot aerosol generating agent to carry out fire-extinguishing tests according to Term 6.3.2 of GA86-2009 respectively at a fire-extinguishing level of 8B. The test results are as shown in Table 1, and 50 g of a commercially available K-type hot aerosol generating agent is applied in a comparison example.

TABLE 1
Comparison of various composition components and comparison of test results

| | | | | | | | | | | | | | Compar- |
|---|---|---|---|---|---|---|---|---|---|---|---|---|---|
| | Component content of embodiments (mass percent) | | | | | | | | | | | | ison |
| Components | 1 | 2 | 3 | 4 | 5 | 6 | 7 | 8 | 9 | 10 | 11 | 12 | example |
| capric acid | 70 | | | | | | | | | | | | 50 g of |
| hexadienic acid | | 75 | | | | | | | | | | | commer- |
| oxalic acid | | | 79.8 | | | | | | | | | | cially |
| malonic acid | | | | 80 | | | | | | | | | available |
| succinic acid | | | | | 80 | | | | | | | | K-type |
| 2-hydroxybutanedioic | | | | | | 75 | | | | | | | hot |
| acid | | | | | | | | | | | | | aerosol |
| 2,3-dihydroxybutane- | | | | | | | 70 | | | | | | generating |
| dioic acid | | | | | | | | | | | | | agent |
| 2-hydroxy-1,2,3- | | | | | | | | 75 | | | | | |
| propanetricarboxylic | | | | | | | | | | | | | |
| acid | | | | | | | | | | | | | |
| 3-phenyl-2-propenoic | | | | | | | | | 80 | | | | |
| acid | | | | | | | | | | | | | |
| 2-hydroxybenzoic acid | | | | | | | | | | 80 | | | |
| 3,4,5-trihydroxy | | | | | | | | | | | 85 | | |
| benzoic acid | | | | | | | | | | | | | |
| N-methylguanidino- | | | | | | | | | | | | 85 | |
| acetic acid | | | | | | | | | | | | | |
| ammonium oxalate | 19 | | | | | | | | 5 | | | | |
| melamine | | | | 4 | | 9 | 25 | 9.5 | | 19 | | 1.5 | |
| manganese carbonate | | 14 | | | | 10 | | | 5 | | 13 | | |
| potassium citrate | | | | | | | | 15 | | | | 12 | |
| sodium citrate | | | | 15 | | | | | 9 | | | | |
| water glass | | | | 1 | | | | | 1 | | 1 | | |
| magnesium stearate | | | | | 5 | 5 | | | | 0.2 | | 0.5 | |
| zinc stearate | | | | | 5 | | | | | | 1 | | |
| hydroxypropyl | | 1 | 0.2 | | | | 5 | 0.5 | | 0.8 | | | |
| methylcellulose | | | | | | | | | | | | | |
| polyvinyl alcohol | 0.8 | | | | 1 | 1 | | | | | | 1 | |
| ferrocene | 9.2 | 9 | 20 | | 9 | | | | | | | | |
| hydroxyethyl cellulose | 1 | 1 | | | | | | | | | | | |
| nozzle temperature | 92 | 97 | 100 | 120 | 98 | 142 | 103 | 76 | 89 | 85 | 69 | 106 | 469 |
| of generator (° C.) | | | | | | | | | | | | | |
| fire-extinguishing | extin- | extin- | extin- | extin- | extin- | extin- | extin- | extin- | extin- | extin- | extin- | extin- | not |
| result | guished | guished | guished | guished | guished | guished | guished | guished | guished | guished | guished | guished | extin- |
| | | | | | | | | | | | | | guished |
| fire-extinguishing | 8.1 | 6.4 | 5.6 | 3.7 | 6.1 | 4.8 | 7.3 | 4.6 | 6.7 | 5.8 | 6.4 | 7.5 | |
| time (s) | | | | | | | | | | | | | |

It can be clearly seen from Table 1 that the fire-extinguishing efficiency of compositions using the organic acids in the first to the twelfth embodiments of the disclosure as main fire-extinguishing materials are far better than that in the comparison example, and the fire-extinguishing time is shorter and the generator nozzle temperature is lower than those in the comparison example.

1. A fire-extinguishing composition comprising an organic acid compound, wherein the fire-extinguishing composition comprises an organic acid compound; the content of the organic acid compound is 50% by mass or more;
A pyrotechnic agent is adopted as a heat source and a power source of the fire extinguishing composition; and the purpose of fire extinguishing is achieved by: igniting the pyrotechnic agent, and the fire extinguishing composition performing decomposition reaction and generating a large quantity of fire extinguishing substance under high temperature produced by burning of pyrotechnic agent, and the fire extinguishing substance sprayed out together with the pyrotechnic agent from a nozzle.

2. The fire-extinguishing composition comprising an organic acid compound according to claim 1, wherein the composition further comprises an auxiliary fire-extinguishing material; the auxiliary fire-extinguishing material is one or more of a citrate, an oxalate, a carbonate, ferrocene or ferrocenyl derivative, and the content thereof is more than 0, and less than or equal to 30% by mass.

3. The fire-extinguishing composition comprising an organic acid compound according to claim 1, wherein the composition further comprises a flame retardant; the content of the flame retardant is more than 0, and less than or equal to 50% by mass.

4. The fire-extinguishing composition comprising an organic acid compound according to claim 1, wherein the composition further comprises an additive; the content of the additive is 0.1% to 10% by mass.

5. The fire-extinguishing composition comprising an organic acid compound according to claim 4, wherein the additive is a water-soluble compound solution or a mixture of a stearate, graphite, and a polymer, or is one or more of water glass, phenol resin, shellac and starch.

6. The fire-extinguishing composition comprising an organic acid compound according to claim 4, wherein the organic acid compound is capric acid, dodecanoic acid, tetradecanoic acid, hexadecanoic acid, heptadecanoic acid, octadecanoic acid, eicosanoic acid, docosanoic acid, hexacosanoic acid, hentriacontylic acid, dotriacontanoic acid, crotonic acid, oleic acid, heptadecenoic acid, hexadecenoic acid, hexadienic acid, oxalic acid, malonic acid, succinic acid, glutaric acid, pimelic acid, suberic acid, sebacic acid, brassylic acid, hexadecanedioic acid, cis-crotonic acid, trans-crotonic acid, 2-hydroxypropionic acid, 2-hydroxybutanedioic acid, 2,3-dihydroxybutanedioic acid, 2-hydroxy-1,2,3-propanetricarboxylic acid, 3-phenyl-2-propenoic acid, 2-hydroxybenzoic acid, 3,4,5-trihydroxy benzoic acid, benzoic acid or methylguanidoacetic acid.

7. The fire-extinguishing composition comprising an organic acid compound according to claim 6, wherein the content of the organic acid compound is preferably 70% to 90% by mass.

8. The fire-extinguishing composition comprising an organic acid compound according to claim 3, wherein the flame retardant is a bromine-based flame retardant, a chlorine-based flame retardant, an organophosphorus-based flame retardant, a phosphorus-halogen based flame retardant, a nitrogen-based and phosphorus-nitrogen flame retardant, other flame retardants, or any combination thereof.

9. The fire-extinguishing composition comprising an organic acid compound according to claim 8, wherein the content of the flame retardant is more than 0 and less than 30% by mass.

10. The fire-extinguishing composition comprising an organic acid compound according to claim 1, wherein the fire-extinguishing composition further comprises:

| | |
|---|---|
| an auxiliary fire-extinguishing material | 4% to 25% by mass; |
| a flame retardant | 4% to 25% by mass; |
| an additive | 0.1% to 5% by mass. |

11. The fire-extinguishing composition comprising an organic acid compound according to claim 2, wherein the composition further comprises an additive; the content of the additive is 0.1% to 10% by mass.

12. The fire-extinguishing composition comprising an organic acid compound according to claim 3, wherein the composition further comprises an additive; the content of the additive is 0.1% to 10% by mass.

13. The fire-extinguishing composition comprising an organic acid compound according to claim 11, wherein the additive is a water-soluble compound solution or a mixture thereof of a stearate, graphite, and a polymer, or one or more of water glass, phenol resin, shellac and starch.

14. The fire-extinguishing composition comprising an organic acid compound according to claim 12, wherein the additive is a water-soluble compound solution or a mixture thereof of a stearate, graphite, and a polymer, or one or more of water glass, phenol resin, shellac and starch.

15. The fire-extinguishing composition comprising an organic acid compound according to claim 11, wherein the organic acid compound is capric acid, dodecanoic acid, tetradecanoic acid, hexadecanoic acid, heptadecanoic acid, octadecanoic acid, eicosanoic acid, docosanoic acid, hexacosanoic acid, hentriacontylic acid, dotriacontanoic acid, crotonic acid, oleic acid, heptadecenoic acid, hexadecenoic acid, hexadienic acid, oxalic acid, malonic acid, succinic acid, glutaric acid, pimelic acid, suberic acid, sebacic acid, brassylic acid, hexadecanedioic acid, cis-crotonic acid, trans-crotonic acid, 2-hydroxypropionic acid, 2-hydroxybutanedioic acid, 2,3-dihydroxybutanedioic acid, 2-hydroxy-1,2,3-propanetricarboxylic acid, 3-phenyl-2-propenoic acid, 2-hydroxybenzoic acid, 3,4,5-trihydroxy benzoic acid, benzoic acid or methylguanidoacetic acid.

16. The fire-extinguishing composition comprising an organic acid compound according to claim 12, wherein the organic acid compound is capric acid, dodecanoic acid, tetradecanoic acid, hexadecanoic acid, heptadecanoic acid, octadecanoic acid, eicosanoic acid, docosanoic acid, hexacosanoic acid, hentriacontylic acid, dotriacontanoic acid, crotonic acid, oleic acid, heptadecenoic acid, hexadecenoic acid, hexadienic acid, oxalic acid, malonic acid, succinic acid, glutaric acid, pimelic acid, suberic acid, sebacic acid, brassylic acid, hexadecanedioic acid, cis-crotonic acid, trans-crotonic acid, 2-hydroxypropionic acid, 2-hydroxybutanedioic acid, 2,3-dihydroxybutanedioic acid, 2-hydroxy-1,2,3-propanetricarboxylic acid, 3-phenyl-2-propenoic acid, 2-hydroxybenzoic acid, 3,4,5-trihydroxy benzoic acid, benzoic acid or methylguanidoacetic acid.

17. The fire-extinguishing composition comprising an organic acid compound according to claim 15, wherein the content of the organic acid compound is preferably 70% to 90% by mass.

18. The fire-extinguishing composition comprising an organic acid compound according to claim 16, wherein the content of the organic acid compound is preferably 70% to 90% by mass.
